(19) United States
(12) Patent Application Publication
(10) Pub. No.: US 2007/0299731 A1
(43) Pub. Date: Dec. 27, 2007

(54) MANUFACTURING OPTIMIZATION IN SUPPORT OF COMPLEX SOLUTION DELIVERY

(76) Inventors: Steven C. Erickson, Rochester, MN (US); Patrick John Reuvers, Rochester, MN (US); William Robert Taylor, Rochester, MN (US)

Correspondence Address: DUKE W. YEE;YEE & ASSOCIATES, P.C., P.O. BOX 802333, DALLAS, TX, 75380, US

(21) Appl. No.: 11/426,484

(22) Filed: Jun. 26, 2006

(51) Int. Cl. G06Q 30/00

(52) U.S. Cl. 705/26

(57) ABSTRACT

A computer implemented method, system, and computer usable program code are provided for processing orders. An order is received for processing and each order may contain a plurality of products. A set of build entities is formed from the order. Each build entity in the set of build entities corresponds to one or more products in the plurality of products. Finally, a set of production orders is created for the set of build entities. Release dates/times for the set of production orders are formed using a shipping entity for the order and production for the set of production orders is configured to minimize work-in-progress.

### BACKGROUND OF THE INVENTION

1. Field of the Invention

The present application relates generally to manufacturing optimization. More particularly, the present application relates to a computer implemented method, system, and computer usable program code for manufacturing optimization in support of complex solution delivery.

2. Description of the Related Art

Many customers want the ability to order multiple customized and/or standard products that are to be installed and used together as a complex “solution” at installation. Various products that constitute customer orders are often times produced on separate manufacturing lines using different tooling optimized for each product. Each of these manufacturing lines is measured on their efficiency and optimizes their operations to produce and ship products without collecting work-in-progress (WIP) at the back end of the manufacturing line. Collecting work-in-progress means that some part, but not all, of the products requested by a customer is ready to ship. These products are being held and/or stored waiting for other products so that a complete shipment may be made to the customer. A shipping department must have these products logistically tied together for shipment to the end customer. The scheduling and production management must be done in an automated and controlled manner without driving additional cost.

A current approach used to solve such “solutions” manages all of the products together as a single order on a flexible manufacturing line that can handle all of the products. However, this type of single-order management becomes unmanageable as the number of these multi-product orders increase. Single order management also requires that an order may not ship until all parts are complete. That is, there is little flexibility to break the hard ties in manufacturing. Thus, manufacturing layout and processes for a single product are difficult to optimize. The multiple products in the “solution” are manually managed through their individual production lines through different communication methods, such as email and phone calls, and products are held in a work-in-progress common area until everything is ready for shipment.

An additional known solution consolidates products that happen to show up for shipping at the same time. In this solution, there are no automated controls across the manufacturing lines to ensure that products are ready at the same point in time. Each product is scheduled for production based on the rules used for a given production line. However, this does not meet the customer requirement for a single shipment because, in many cases, sub-optimized scheduling decisions are made in each production area.

Another known solution uses “in-transit” product consolidation centers to group items together before final customer delivery. However, this increases handling costs, transit time, work-in-progress holding costs, and delays payment.

### BRIEF SUMMARY OF THE INVENTION

The different aspects of the illustrative embodiments provide a computer implemented method, system, and computer usable program code for processing orders. The illustrative embodiments receive an order for processing. Each order may contain a plurality of products. The illustrative embodiments form a set of build entities from the order. A build entity in the set of build entities may correspond to one or more products in the plurality of products. The illustrative embodiments create a set of production orders for the set of build entities. The release dates/times for the set of production orders is formed using a shipping entity for the order and production for the set of production orders is configured to minimize work-in-progress.

### BRIEF DESCRIPTION OF THE SEVERAL VIEWS OF THE DRAWINGS

The novel features believed characteristic of the illustrative embodiments are set forth in the appended claims. The aspects of the illustrative embodiment, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 illustrates a function block diagram of the components used in a manufacturing optimization system in accordance with an illustrative embodiment;

FIG. 4 is an example of an optimized manufacturing process in accordance with an illustrative embodiment;

FIG. 5 illustrates an operation of receiving an order in accordance with an illustrative embodiment;

FIG. 6 depicts an operation of determining build entities in accordance with an illustrative embodiment;

FIG. 7 depicts an operation of determining ship entities in accordance with an illustrative embodiment; and

FIG. 8 depicts a flow diagram of the manufacturing optimization operation in accordance with an illustrative embodiment.

### DETAILED DESCRIPTION OF THE INVENTION

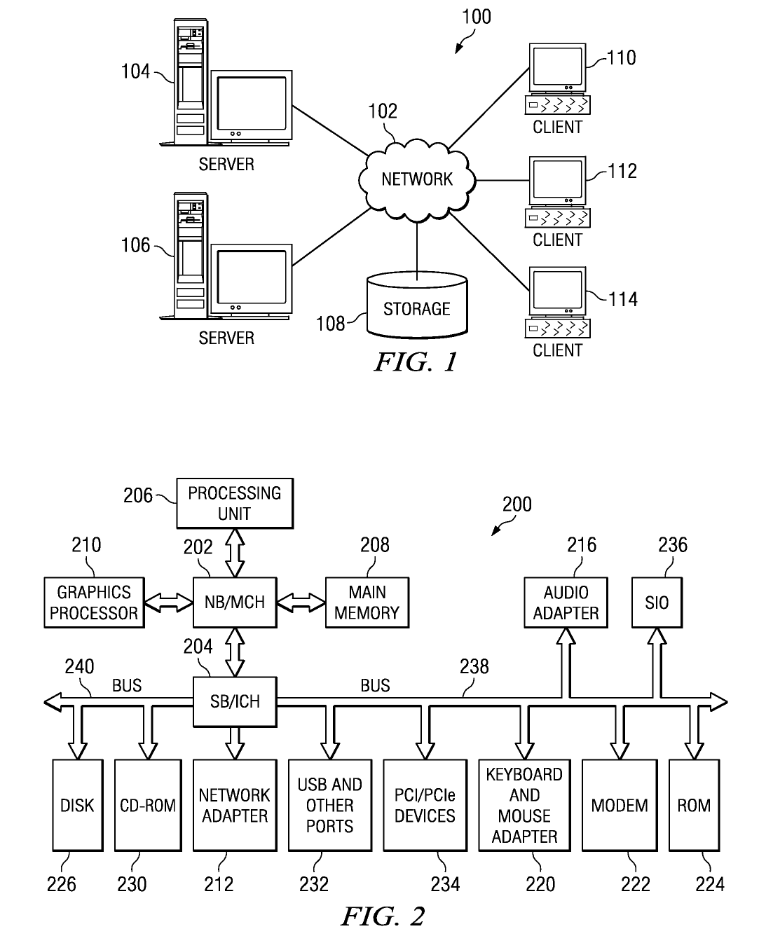

The illustrative embodiments provide for manufacturing optimization of complex solution delivery. With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments create the concept of a ship entity, which is comprised of groupings of multiple generic or customized products. Each of these customized or generic product groupings become a production order that is manufactured on a manufacturing line. These production orders or groups of products are referred to as build entities. The production for the set of production orders is configured to minimize work-in-progress. The start-to-build date/time schedule is customized for each build entity based on the ship entity schedule and the various product lead times in the manufacturing process. Some products may have lead times measured in hours as opposed to days, thus the illustrative embodiments allow for production orders to be released based on a time as well as a date. The release dates/times for the production orders are determined using the shipping entity for the order. This minimizes product wait time while still meeting customer requirements. The shipping entity has automated work direction to consolidate multiple build entities into a single shipment for the end customer. Build entity manufacturing is automatically triggered to start based on scheduled release offset dates/times or by the start of other build entities tied to the same ship entity.

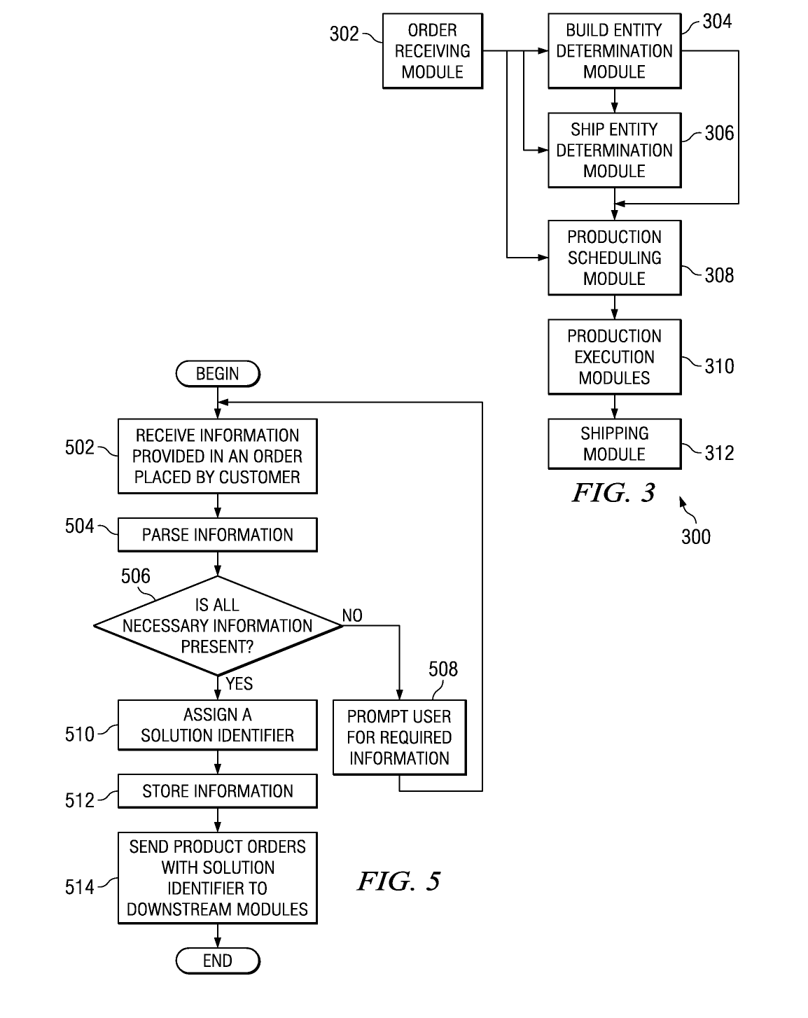

FIG. 3 illustrates a functional block diagram of the components used in a manufacturing optimization system in accordance with an illustrative embodiment. The components are modules that are part of an application that may be executed by a data processing system, such as data processing system 200 of FIG. 2, on a client or server, such as client 110, 112, or 114, or server 104 or 106 of FIG. 1. Manufacturing optimization solution 300 is composed of order receiving module 302, build entity determination module 304, ship entity determination module 306, production scheduling module 308, production execution modules 310, and shipping module 312. Order receiving module 302 receives orders from customers through email, Web pages, phone orders, etc. Order receiving module 302 receives orders directly from customers or indirectly via a multi-plant order routing system. Order receiving module 302 assigns a solution identifier to all the various product orders received. Order receiving module 302 then sends the set of product orders including the associated solution identifier and related information to the build entity determination module 304, ship entity determination module 306, and production scheduling module 308.

The orders received from the customer may represent the total set of the products requested by the customer, the delivery date the customer wants the products, the location where the products are to be shipped, as well as other pertinent information. A “solution” to the customer's order represents the grouping of products that a customer wants to purchase together. A customer will typically define one or more ship-to addresses and may also define when products are desired to arrive at each ship-to location, i.e. a request date. Each logical grouping of products within the customer's order that must be built together as a single build entity and tested together in a single manufacturing plant is referred to as a build entity. A production order or build entity represents a single group of products that must be built/tested/managed together during the manufacturing process. From a manufacturing point of view, each build entity is a single production order. A single build entity must be started and completed as a unit within the manufacturing process. Each logical grouping of products in one or more build entities that must be shipped together from a single manufacturing plant to a single customer ship-to location and for a specified request date is referred to as a ship entity.

An exemplary order may be where a customer has a design for a new computer system for each of ten large stores. The order requires a computer rack with multiple customized servers installed in it as well as some displays, personal computers, and other equipment. The customer has an installation team that will be traveling to each store on a specific schedule to install and put the new systems into production. The customer requires that each order for each store is delivered based on this schedule. The solution results in ten ship entities that each have multiple required build entities. The manufacturing systems need to coordinate the production of the associated build entities within each ship entity. The manufacturing team will also have to communicate with the customer or sales representative if any part of the ship entity is delayed due to quality, rework, or parts shortages and determine if a partial shipment is desired.

Build entity determination module 304 determines which products must be built and/or tested together. Individual products are the lowest level of orderable product, such as a power cord, a shelf, or other single part item. Tied products are products that consist of numerous parts made on different manufacturing lines that require some type of assembly prior to shipping. Build entity determination module 304 assigns a build entity identifier to the product orders. The build entity identifier identifies which products are built together as a single production order and tested together in a single manufacturing plant. Build entity determination module 304 then sends the order information with the build entity identifiers to ship entity determination module 306.

Ship entity determination module 306 uses the build entity information from build entity determination module 304 along with the information in the order to determine which products will be required to be shipped together and assigns ship entity identifiers to the individual product orders. The ship entity information is sent to production scheduling module 308. Production scheduling module 308 uses the order information, build entity information, and ship entity information to produce and assign build entities/production orders to the appropriate manufacturing lines with start to build dates/times, also referred to as release dates/times, based on known production lead times such that all production orders in the ship entity will complete at the same time and on the required date for common shipment. Production scheduling module 308 uses estimated timelines associated with the manufacturing of each product to create a production schedule. The production orders are configured to release on specific dates/times, so that work-in-progress is minimized. That is, completed products are not waiting around for other products to be manufactured in order for the entire shipment to be shipped at a single time. Each of the production orders are synchronized with the determined production schedule.

The production orders are stored and sent to the required production execution modules 310 once a release date/time is encountered. Each of production execution modules 310 represent a manufacturing plant or build entity where the products are built. Thus, each product, individual or tied, has an associated build entity. The manufacturing plants use their respective production execution modules 310 to determine the production orders they are required to build. Then the manufacturing plant manufactures the product(s) per the production order. Each manufacturing plant then updates its respective production execution modules 310 as to the status of the build entity. Once the product or build entity is complete, it is shipped to a shipping facility and an associated shipping module 312 is updated that the product has been sent.

The shipping facility uses shipping module 312 to ensure receipt of each completed build entity from the various manufacturing lines. Shipping module 312 prepares entire ship entity as a single shipment, such as preparing labels, paperwork, interfaces to transportation vendors, etc. The shipping facility has automated work direction to consolidate multiple build entities into a single shipment for the end customer.

Production scheduling module 308 constantly monitors the timelines associated with each product and/or part. If a timeline is changed at any point during manufacturing or prior to a production order being sent to the appropriate production execution modules 310, production scheduling module 308 is able to modify any pending production orders to minimize the number or products that will have to be temporarily stored at the shipping facility. If a delay is encountered during manufacturing, production scheduling module 308 notifies shipping module 312 of the delay and estimated time of delay. Although only one shipping module is shown, there may be many shipping modules representing regional ship locations.

Thus, the optimization of releasing production orders to manufacturing plants only when a release date/time is encountered, decreases the amount of products waiting at a shipping facility for other products that are still being manufactured.

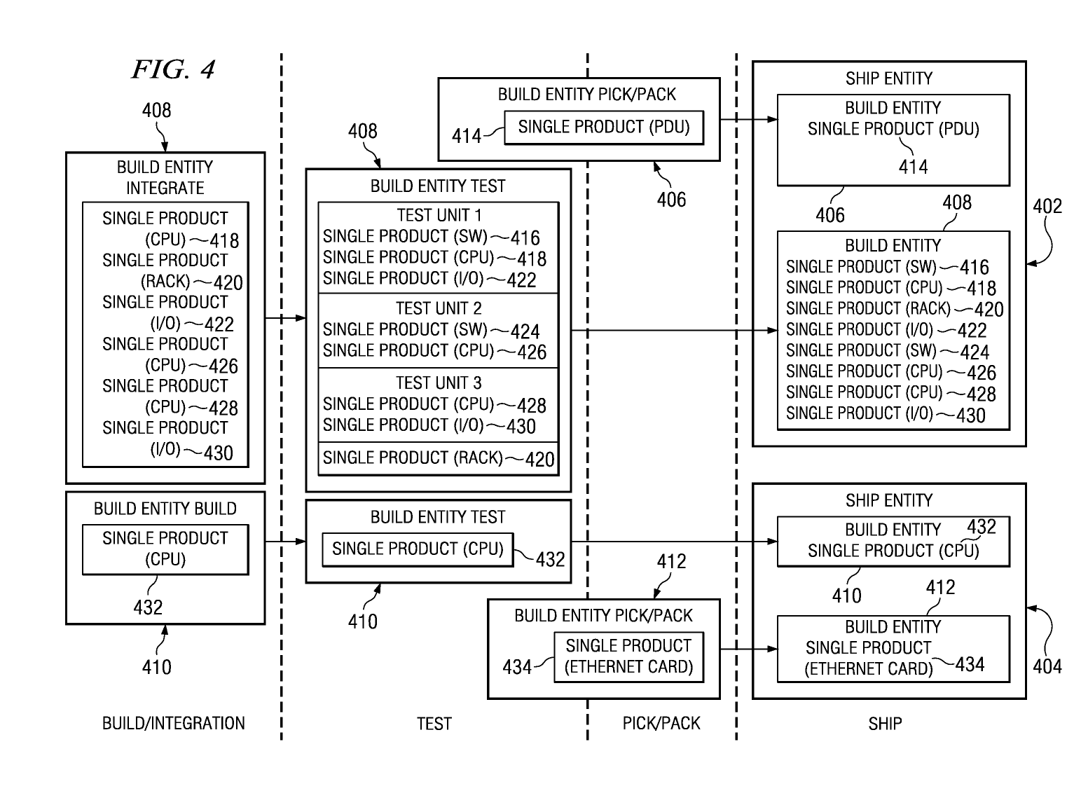

FIG. 4 is an example of an optimized manufacturing process in accordance with an illustrative embodiment. In this example, a customer has ordered a number of products that are to be shipped to two different locations and delivered at two different times. In this illustrative example, ship entity 402 is to be sent to Location 1 and is to arrive on April 1^{st}. Ship entity 404 is to be sent to Location 2 and is to arrive on April 15^{th} Shipping entities 402 and 404 represent a collection of products ordered by a customer that is to be sent as a complete solution to a specific location on a specific date. The products that have been ordered are analyzed by a build entity determination module, such as build entity determination module 304 of FIG. 3, to determine which of single products 414-434 must be built and/or tested together and assign a build entity identifier to the product orders. Build entity 408 is a tied product while build entities 406, 410, and 412 are individual products.

A ship entity determination module, such as ship entity determination module 306 of FIG. 3, uses the order information and the build entity determination information to determine which of single products 414-434 will be required to be shipped together and assigns ship entity identifiers to each of single products 414-434. As shown in this example, build entities 406 and 408 are required to ship together and build entities 410 and 412 are required to ship together. A production scheduling module, such as production scheduling module 308 of FIG. 3, analyzes the order information, build entity determination information, the ship entity information, and estimated timelines associated with building each product in each of build entities 406, 408, 410, and 412 to assign build entities/production orders for each of single products 414-434 to the appropriate manufacturing lines with start to build dates/times, or release dates/times, based on known production lead times such that all production orders in the ship entity will complete at the same time and on the required date for common shipment. Production orders for single products 414-434 will be released to each of build entities 406, 408, 410, or 412 on a release date/time that will meet the delivery date specified by the customer. Thus, the build or manufacturing priorities are coordinated for each build entity based on the ship entity. The production scheduling module synchronizes the production orders with the determined production schedule.

As shown in FIG. 4, build entities 408 and 410 require production orders for single products 418, 420, 422, 426, 428, 430, and 432 to be released much earlier than production orders for single products 416 and 424 in build entities 408 and 410 and production orders for single products 414 and 434 in build entities 406 and 412. Therefore, production orders for single products 418, 420, 422, 426, 428, and 430 are released to the manufacturing plant responsible for build entity 408, where the multi-part product is built, integrated, and tested. Additionally, production orders for single product 432 is released at a later date to the manufacturing plant responsible for build entity 410 where the product is an individual product that requires testing. As shown, production orders for single products 416 and 424 are released at a time after the integration of single products 418, 420, 422, 426, 428, and 430 so that single products 416 and 424 will be tested along with single products 418, 420, 422, 426, 428, and 430.

During the end of testing of build entities 408 and 410, production orders for single products 414 and 434 are released to the manufacturing plant responsible for build entities 406 and 412 in order that the time to pick and pack these individual products will be approximately the time that testing at build entities 408 and 410 complete testing of single products 416, 418, 420, 422, 424, 426, 428, 430, and 432. Thus, the single products provided by build entities 406 and 408 are estimated to arrive at the shipping facility at approximately the same time so that ship entity 402 may ship together and no products require temporary storage. Also, the single products provided by build entities 410 and 412 are estimated to arrive at the shipping facility at approximately the same time so that ship entity 404 may ship together and no products require temporary storage.

FIG. 5 illustrates an operation of receiving an order in accordance with an illustrative embodiment. A customer order is received in an order receiving module, such as order receiving module 302 of FIG. 3. As the operation begins, the information provided by a customer, either directly or indirectly, is received by the order receiving module (step 502). The information is parsed (step 504) and a determination is made if all necessary information has been provided (step 506). If there is any missing information, the order receiving module prompts the user for the required information (step 508) with the operation returning to step 502. If all the information needed is provided at step 506, the order receiving module assigns a solution identifier to all the various product orders received (step 510) and the information is stored in a data structure (step 512). The order receiving module sends all pertinent information to other downstream modules (step 514), with the operation terminating thereafter.

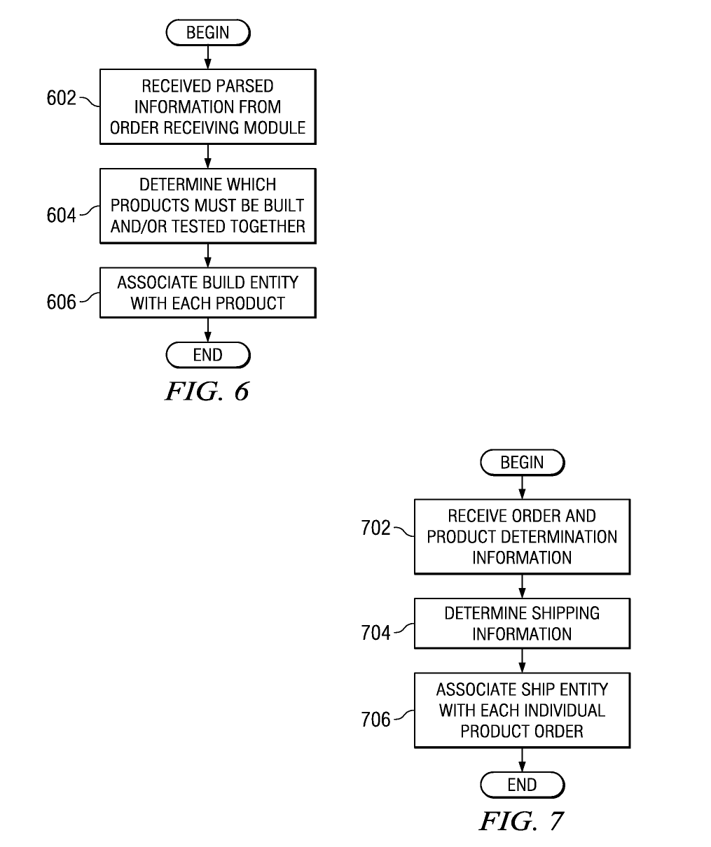

FIG. 6 depicts an operation of determining build entities in accordance with an illustrative embodiment. Build entity determination is provided in a build entity determination module, such as build entity determination module 304 of FIG. 3. As the operation begins, the parsed information is received from the order receiving module (step 602). The build entity determination module determines which products must be built and/or tested together (step 604). The build entity determination module then assigns build entity identifiers to the product orders (step 606), with the operation terminating thereafter.

FIG. 7 depicts an operation of determining ship entities information in accordance with an illustrative embodiment. Ship entity determination is provided in a ship entity determination module, such as ship entity determination module 306 of FIG. 3. As the operation begins, the ship entity determination module receives information from the order receiving module and the build entity determination module (step 702). The ship entity determination module uses the build entity information from the build entity determination module along with the information in the order to determine which products will be required to be shipped together (step 704). Using the determined information, the ship entity determination module assigns ship entity identifiers to the individual product orders (step 706), with the operation terminating thereafter.

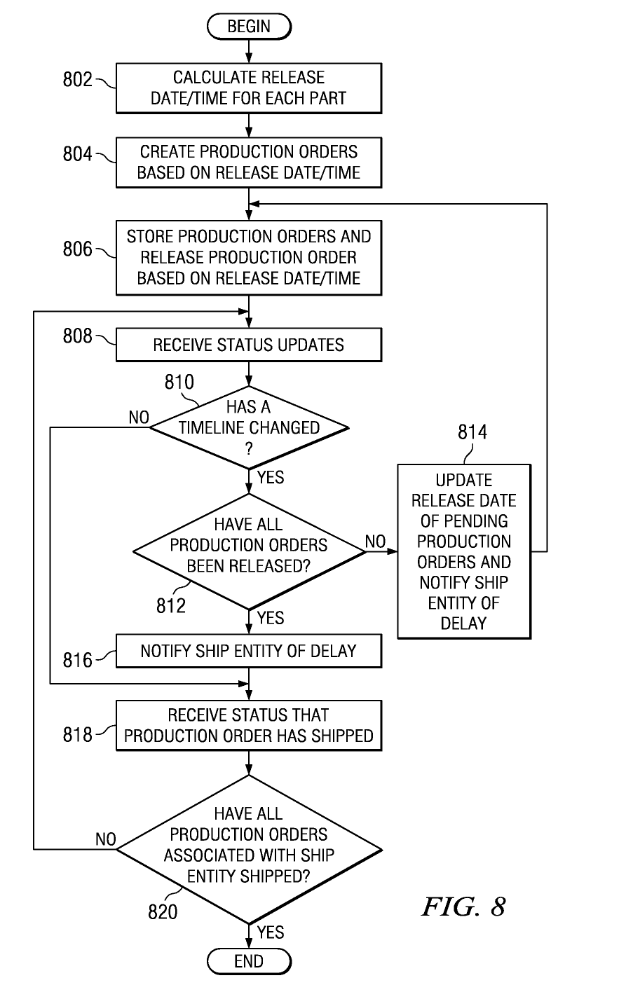

FIG. 8 depicts a flow diagram of the manufacturing optimization operation in accordance with an illustrative embodiment. As the operation begins, a production scheduling module, such as production scheduling module 308 of FIG. 3, uses the received order information, build entity information, and ship entity information along with estimated timeline information to calculate a release date/time for each product associated with the customer's order (step 802). The production scheduling module then coordinates and assigns build entities/production orders to the appropriate manufacturing line(s) with release dates/times based on known production lead times such that all production orders in the ship entity will complete at the same time and on the required date for common shipment (step 804). Thus, the production orders are synchronized with a determined production schedule. The production orders are stored and sent to production once a release date/time is encountered (step 806). As the products are manufactured and completed in each build entity, the production scheduling module receives status updates (step 808). Production scheduling module determines whether the status updates are timeline changes (step 810).

If the status update is a timeline change, the production scheduling module determines whether all production orders related to a specific ship entity have been released (step 812). If there are pending production orders that have not been release, production scheduling module updates the release date/time of those production orders and notifies the ship entity that a delay has been encountered (step 814). The notification to the ship entity provides a warning that part of a ship entity may need to be temporarily stored. If at step 812, all production orders have been released, the production scheduling module notifies the ship entity of the encountered delay (step 816) with the operation continuing to step 818. If at step 810, the status update is not a time line change, the production scheduling module waits for a status that the production order has completed (step 818).

Once all production orders related to a specific ship entity have completed, the ship entity is prepared as a single shipment and shipped (step 820). Once the ship entity ships, the operation terminates. If production orders associated with a ship entity are still pending, the operation returns to step 808.

Thus, the illustrative embodiments receive an order for processing and the order contains a plurality of products. A set of build entities are formed from the order and each build entity in the set of build entities corresponds to one or more products in the plurality of products. The illustrative embodiments create a set of production orders for the set of build entities. Release dates/times for the set of production orders are formed using a shipping entity for the order and production for the set of production orders is optimized to minimize work-in-progress.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing orders, the computer implemented method comprising:
receiving an order for processing, wherein the order contains a plurality of products;
forming a set of build entities from the order, wherein a build entity in the set of build entities corresponds to one or more products in the plurality of products; and
creating a set of production orders for the set of build entities, wherein release dates/times for the set of production orders is formed using a shipping entity for the order and production for the set of production orders is configured to minimize work-in-progress.

2. The computer implemented method of claim 1, further comprising:
synchronizing production schedules for the production orders.

3. The computer implemented method of claim 1, further comprising:
coordinating build priorities for each build entity based on the ship entity.

4. The computer implemented method of claim 1, wherein the shipping entity represents a location and delivery date for the order.

5. The computer implemented method of claim 1, further comprising:
storing the set of production orders; and
responsive to a release date/time for a production order in the set of production orders being met, releasing the production order for manufacturing.

6. The computer implemented method of claim 1, further comprising:
receiving a status update of the production order;
determining whether the status update is a manufacturing timeline delay;
responsive to the manufacturing timeline delay, updating the release date/time of the set of production orders that are pending; and
sending a notification of the manufacturing timeline delay.

7. The computer implemented method of claim 1, further comprising:
determining if all of the set of production orders are fulfilled; and
responsive to all of the set of production orders being fulfilled, closing the order for the set of products.

8. The computer implemented method of claim 1, wherein the order specifies a delivery date for each product within the set of products and a desired configuration of the set of products.

9. A data processing system comprising:
a bus system;
a communications system connected to the bus system;
a memory connected to the bus system, wherein the memory includes a set of instructions; and
a processing unit connected to the bus system, wherein the processing unit executes the set of instructions to receive an order for processing, wherein the order contains a plurality of products; form a set of build entities from the order, wherein a build entity in the set of build entities corresponds to one or more products in the plurality of products; and create a set of production orders for the set of build entities, wherein release dates/times for the set of production orders is formed using a shipping entity for the order and production for the set of production orders is configure to minimize work-in-progress.

10. The data processing system of claim 9, wherein the processing unit executes the set of instructions to synchronize production schedules for the production orders.

11. The data processing system of claim 9, wherein the processing unit executes the set of instructions to coordinate build priorities for each build entity based on the ship entity.

12. The data processing system of claim 9, wherein the processing unit executes the set of instructions to store the set of production orders; and release the production order for manufacturing in response to a release date/time for a production order in the set of production orders being met.

13. The data processing system of claim 9, wherein the processing unit executes the set of instructions to receive a status update of the production order; determine whether the status update is a manufacturing timeline delay; update the release date/time of the set of production orders that are pending in response to the manufacturing timeline delay; and send a notification of the manufacturing timeline delay.

14. The data processing system of claim 9, wherein the processing unit executes the set of instructions to determine if all of the set of production orders are fulfilled; and close the order for the set of products in response to all of the set of production orders being fulfilled.

15. A computer program product comprising:
a computer usable medium including computer usable program code for processing orders, the computer program product including:
computer usable program code for receiving an order for processing, wherein the order contains a plurality of products;
computer usable program code for forming a set of build entities from the order, wherein a build entity in the set of build entities corresponds to one or more products in the plurality of products; and
computer usable program code for creating a set of production orders for the set of build entities, wherein release dates/times for the set of production orders is formed using a shipping entity for the order and production for the set of production orders is configure to minimize work-in-progress.

16. The computer program product of claim 15, further including:
computer usable program code for synchronizing production schedules for the production orders.

17. The computer program product of claim 15, further including:
computer usable program code for coordinating build priorities for each build entity based on the ship entity.

18. The computer program product of claim 15, further including:
computer usable program code for storing the set of production orders; and
computer usable program code for releasing the production order for manufacturing in response to a release date/time for a production order in the set of production orders being met.

19. The computer program product of claim 15, further including:
computer usable program code for receiving a status update of the production order;
computer usable program code for determining whether the status update is a manufacturing timeline delay;
computer usable program code for updating the release date/time of the set of production orders that are pending in response to the manufacturing timeline delay; and
computer usable program code for sending a notification of the manufacturing timeline delay.

20. The computer program product of claim 15, further including:
computer usable program code for determining if all of the set of production orders are fulfilled; and
computer usable program code for closing the order for the set of products in response to all of the set of production orders being fulfilled.
